(19) United States
(12) Patent Application Publication
(10) Pub. No.: US 2024/0021933 A1
(43) Pub. Date: Jan. 18, 2024

(54) POWER STORAGE MODULE

(71) Applicant: KABUSHIKI KAISHA TOYOTA JIDOSHOKKI, Kariya-shi, Aichi (JP)

(72) Inventors: Yuki OKAMOTO, Kariya-shi, Aichi (JP); Osamu OHMORI, Kariya-shi, Aichi (JP); Kayo MIZUNO, Kariya-shi, Aichi (JP); Mutsumi TAKAHASHI, Kariya-shi, Aichi (JP); Kanae MURASE, Kariya-shi, Aichi (JP)

(73) Assignee: KABUSHIKI KAISHA TOYOTA JIDOSHOKKI, Kariya-shi, Aichi (JP)

(21) Appl. No.: 18/036,073

(22) PCT Filed: Oct. 5, 2021
(86) PCT No.: PCT/JP2021/036841

§ 371 Date: May 9, 2023

(30) Foreign Application Priority Data
Nov. 11, 2020 (JP) 2020-187854

(51) Int. Cl. H01M 50/186; H01M 50/474; H01M 50/477; H01M 50/569; H01G 11/12; H01G 11/80

(52) U.S. Cl. CPC H01M 50/186; H01M 50/474; H01M 50/477; H01M 50/569; H01G 11/12; H01G 11/80

(57) ABSTRACT

A power storage module includes: a stack including power storage cells stacked in a first direction and having stack side surfaces that extends in the first direction; and a sealing member formed in contact with the stack side surfaces. The power storage cells each includes: a first electrode including a first electrode plate having a first surface and a first active material layer formed on the first surface; a second electrode including a second electrode plate having a second surface and a second active material layer having an electrode polarity different from that of the first active material layer and formed on the second surface; and a spacer. A portion of the sealing member disposed on at least one of the stack side surfaces serves as a low elastic modulus portion that has an elastic modulus lower than that of the spacer.

### TECHNICAL FIELD

The present invention relates to a power storage module.

### BACKGROUND ART

A known power storage module is used in a bipolar battery unit described in Patent Literature 1. The bipolar battery unit includes a first current collector, a second current collector, an inner sealing layer formed between the first current collector and the second current collector and on the peripheral portions of the collectors, and an outer sealing layer formed outward of a resin layer serving as the inner sealing layer.

### CITATION LIST

### Patent Literature

Patent Literature 1: Japanese Patent Application Publication No. 2019-175778

### SUMMARY OF INVENTION

### Technical Problem

Regarding the power storage module, it may be understood that a power storage cell includes the first current collector, a negative electrode layer, an insulation layer, a positive electrode layer, and the second current collector stacked on top of each other in this order and the power storage cell is sealed by a sealing layer, such as the inner sealing layer. For example, if gas is generated in such a power storage cell, the gas may expand the power storage cell. If the power storage cell expands, the sealing layer may be peeled from the first current collector and the second current collector, which may decrease the sealing performance of the power storage cell.

The present invention is directed to providing a power storage module that is capable of increasing sealing performance.

### Solution to Problem

A power storage module according to the present invention includes: a stack including a plurality of power storage cells stacked in a first direction; and a sealing member for sealing the stack, the stack has a plurality of stack side surfaces that extends in the first direction, the sealing member is formed in contact with the stack side surfaces, the power storage cells each include: a first electrode including a first electrode plate having a first surface intersecting the first direction and a first active material layer formed on the first surface; a second electrode including a second electrode plate having a second surface intersecting the first direction and a second active material layer having an electrode polarity different from an electrode polarity of the first active material layer and formed on the second surface, the second electrode being stacked on the first electrode such that the second active material layer faces the first active material layer; and a spacer disposed between the first electrode plate and the second electrode plate and surrounding the first active material layer and the second active material layer as viewed from the first direction, and a portion of the sealing member disposed on at least one of the stack side surfaces serves as a low elastic modulus portion that has an elastic modulus lower than an elastic modulus of the spacer.

In the power storage module, the stack includes the plurality of power storage cells stacked in the first direction. The power storage cells each include the first electrode and the second electrode stacked on top of each other, and the spacer disposed between the first electrode and the second electrode. Further, the plurality of stack side surfaces of the stack extending in the first direction has thereon the sealing member for sealing the stack. The portion of the sealing member formed on at least one of the stack side surfaces serves as the low elastic modulus portion that has the elastic modulus lower than the elastic modulus of the spacer of the power storage cell. According to this configuration, if the power storage cell is deformed due to any reason, such as expansion or displacement, the sealing member, which is relatively deformable, may sufficiently deform following the deformation of the power storage cell while securing sealing performance. Therefore, the power storage module may increase sealing performance.

In the power storage module according to the present invention, the first electrode plate may have the first surface and a third surface on opposite sides of the first electrode plate, the second electrode plate may have the second surface and a fourth surface on opposite sides of the second electrode plate, and the stack may include the power storage cells that are stacked on top of each other such that the third surface of the first electrode plate of one power storage cell is overlapped with the fourth surface of the second electrode plate of another power storage cell. This configuration generates an overlapping area of the electrode plates between the adjacent power storage cells. Accordingly, securing sealing performance of the relatively deformable sealing member is effective against a displacement between the stacked power storage cells.

The power storage module according to the present invention may further include a detecting line that is disposed between the third surface and the fourth surface adjacent to each other and connected to at least one of the first electrode plate and the second electrode plate to detect a state of the power storage cell, the detecting line may extend out from the sealing member, and a portion of the sealing member disposed on at least one of the stack side surfaces from which the detecting line extends may serve as the low elastic modulus portion. This configuration allows the proximal portion of the detecting line extending from the stack side surface to be supported by a relatively soft portion of the sealing member. This configuration therefore allows the sealing member to absorb vibration of the detecting line, thereby reducing breaking of the detecting line.

In the power storage module according to the present invention, the portion of the sealing member disposed on the one of the stack side surfaces from which the detecting line extends may have an elastic modulus that is lower than an elastic modulus of the other portion of the sealing member disposed on the others of the stack side surfaces. In this configuration, the other portion of the sealing member disposed on the others of the stack side surfaces except for the stack side surface from which the detecting line extends has a relatively high elastic modulus. This configuration may therefore reduce breaking of the detecting line while securing the stiffness of the whole power storage module.

The power storage module according to the present invention may further include a pair of current collectors respectively disposed at one end and the other end of the stack in the first direction, and the sealing member may have a groove extending in a direction intersecting the first direction as viewed from a second direction intersecting the stack side surface. This configuration allows the groove to extend the creepage distance of the stack side surface between the current collectors. This configuration is likely to prevent water, which may be generated from moisture condensation on the surface of the sealing member, from flowing down on the stack side surface, compared with a configuration where the sealing member has a flat surface as a whole, for example. This therefore prevents a short circuit between the current collectors.

In the power storage module according to the present invention, the groove may extend diagonally to the first direction as viewed from the second direction. This configuration may guide water, which may be generated from moisture condensation on the surface of the sealing member, in a desired direction.

In the power storage module according to the present invention, the spacer may have, on opposite sides of the spacer, an inner side surface facing a space between the first electrode plate and the second electrode plate and an outer side surface, respectively, and a thickness of the sealing member in a direction intersecting the stack side surface may be smaller than a thickness of the spacer between the inner side surface and the outer side surface of the spacer. This configuration secures sealing performance while reducing the size of the power storage module and preventing an increase in manufacturing cost of the power storage module.

In the power storage module according to the present invention, a melting point of the sealing member may be lower than a melting point of the spacer. This may reduce thermal influence on the spacer when the sealing member is formed by welding, slushing, or the like, thereby reducing a decrease in sealing performance.

### Advantageous Effect of Invention

The present invention is directed to providing a power storage module capable of increasing sealing performance.

### BRIEF DESCRIPTION OF DRAWINGS

FIG. 1 is a schematic sectional view of a power storage device according to an embodiment.

FIG. 2 is a schematic plan view of the power storage device illustrated in FIG. 1.

FIG. 3 is a partial side view of the power storage device illustrated in FIG. 1.

FIG. 4 is a partially enlarged sectional view of the power storage device illustrated in FIG. 1.

FIGS. 5(a) and 5(b) are side views illustrating grooves according to modifications.

FIGS. 6(a) and 6(b) are sectional views illustrating grooves according to modifications.

### DESCRIPTION OF EMBODIMENTS

The following will describe an embodiment of a power storage module with reference to figures. In the description with the figures, identical elements or equivalent elements may be denoted by the same sign, and repetitive explanations may be omitted. The respective figures may show a rectangular coordinate system formed of the X-axis, the Y-axis, and the Z-axis.

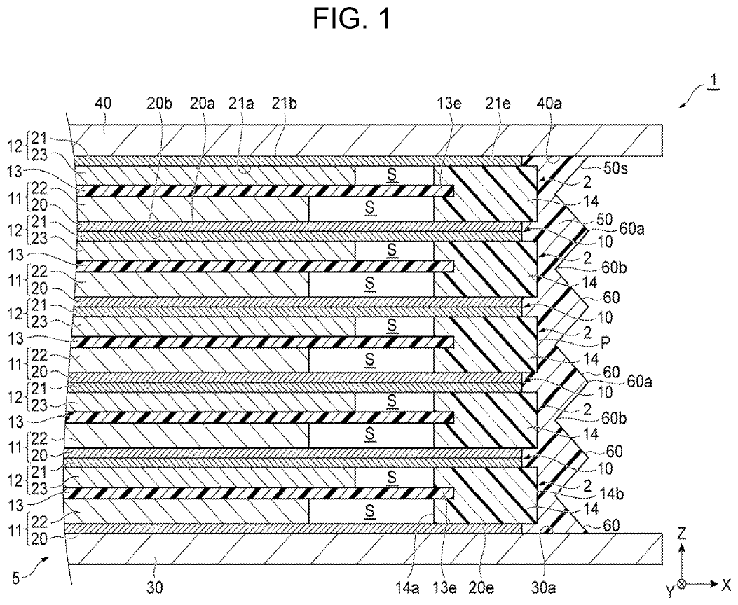

FIG. 1 is a schematic sectional view of a power storage device according to an embodiment. FIG. 1 illustrates a power storage device 1 (power storage module) serving as a power storage module, which is used for a battery for various vehicles, such as a forklift truck, a hybrid vehicle, and an electric vehicle. The power storage device 1 is a secondary battery, such as a nickel-metal hydride battery or a lithium-ion battery. The power storage device 1 may be an electrical double layer capacitor or an all-solid-state battery. In the present embodiment, a lithium-ion battery serves as the power storage device 1.

The power storage device 1 includes a stack 5 that includes a plurality of power storage cells 2 stacked on top of each other in a stack direction (first direction). In the present embodiment, the stack direction of the power storage cells 2 is expressed by the Z-axis direction. Each of the power storage cells 2 includes a positive electrode (first electrode) 11, a negative electrode (second electrode) 12, a separator 13, and a spacer 14. The positive electrode 11 includes a first electrode plate 20 and a positive electrode active material layer (first active material layer) 22 formed on a surface (first surface) 20a of the first electrode plate 20. The positive electrode 11 is an electrode having a rectangular shape, for example. The surface (first surface) 20a intersects the first direction.

The negative electrode 12 includes a second electrode plate 21 and a negative electrode active material layer (second active material layer having an electrode polarity different from an electrode polarity of the first active material layer) 23 formed on a surface (second surface) 21a of the second electrode plate 21. The negative electrode 12 is an electrode having a rectangular shape, for example. The surface (second surface) 21a intersects the first direction. In each power storage cell 2, the negative electrode 12 is stacked on the positive electrode 11 such that the negative electrode active material layer 23 faces the positive electrode active material layer 22. In the present embodiment, the stack direction of the positive electrode 11 and the negative electrode 12 corresponds to the stack direction of the power storage cells 2 (Z-axis direction). In the following description, the stack direction of the power storage cells 2 and the stack direction of the positive electrode 11 and the negative electrode 12 may be simply referred to as the stack direction. In the present embodiment, the positive electrode active material layer 22 and the negative electrode active material layer 23 each have a rectangular shape. The negative electrode active material layer 23 is slightly larger than the positive electrode active material layer 22, so that the whole formation area of the positive electrode active material layer 22 is located within the formation area of the negative electrode active material layer 23 in planar view (as viewed from the stack direction).

The first electrode plate 20 has the surface 20a and the other surface (third surface) 20b on opposite sides of the first electrode plate 20. The other surface 20b does not have the positive electrode active material layer 22. The second electrode plate 21 has the surface 21a and the other surface (fourth surface) 21b on opposite sides of the second electrode plate 21. The other surface 21b does not have the negative electrode active material layer 23. The stack 5 includes the stacked power storage cells 2, wherein the power storage cells 2 are stacked on top of each other such that the other surface 20b of the first electrode plate 20 of one power storage cell 2 is overlapped with the other surface 21b of the second electrode plate 21 of another power storage cell 2 adjacent to the one power storage cell 2 in the stack direction.

This configuration allows the power storage cells 2 to be electrically connected in series in the stack 5. In the stack 5, the power storage cells 2 adjacent to each other in the stack direction form a quasi bipolar electrode 10 in which the first electrode plate 20 and the second electrode plate 21 in contact with each other serve as electrodes. In other words, one bipolar electrode 10 includes the first electrode plate 20, the second electrode plate 21, the positive electrode active material layer 22, and the negative electrode active material layer 23. The first electrode plate 20 (positive electrode 11) is arranged at an end in the stack direction to serve as a terminal electrode. The second electrode plate 21 (negative electrode 12) is arranged at the other end in the stack direction to serve as a terminal electrode. In the present embodiment, a direction along the surfaces 20a, 21a and a direction along the other surfaces 20b, 21b are respectively expressed by the X-axis direction and the Y-axis direction. Each bipolar electrode 10 may be formed of a single electrode plate that has the positive electrode active material layer 22 and the negative electrode active material layer 23 on opposite sides of the single electrode plate. In this configuration, each power cell 2 is formed between the electrode plates of the adjacent bipolar electrodes 10.

Each of the first electrode plate 20 and the second electrode plate 21 (which may be simply referred to as the electrode plate in the following description) is a chemically inactive electric conductor for continuously passing electric current to the positive electrode active material layer 22 and the negative electrode active material layer 23 during charge or discharge of the lithium-ion battery. Examples of the material for the electric plate may include a metallic material, a conductive resin material, and a conductive inorganic material. Examples of the conductive resin material include resin in which conductive filler is added to conductive polymer or non-conductive polymer as necessary. The electrode plate may include a plurality of layers that includes at least one layer formed of the metallic material or the conductive resin material. The surface of the electrode plate may be coated with a known protective layer. The surface of the electrode plate may be treated by a known process, such as plating.

The electrode plate may have the form of foil, sheet, film, wire, bar, mesh, clad, or the like. The electrode plate may be formed of metallic foil, such as nickel foil, titanium foil, or stainless steel foil, in addition to aluminum foil and copper foil. To secure mechanical strength, the electrode plate may be formed of stainless steel foil (e.g., SUS304, SUS316, SUS301, SUS304, specified in JIS G4305: 2015). The electrode plate may be formed of alloy foil of the aforementioned metals. The first electrode plate 20 may be formed of foil that includes a base material coated with an aluminum film. In the present embodiment, the first electrode plate 20 and the second electrode plate 21 are formed of aluminum foil and copper film, respectively. The second electrode plate 21 may be formed of foil that includes a base material coated with a copper film. When the electrode plate has the form of foil, the thickness of the electrode plate may range from 1 μm to 100 μm.

The positive electrode active material layer 22 includes a positive electrode active material that is capable of charging and discharging charge carriers, such as lithium-ion. The positive electrode active material may be selected from any materials applicable for a positive electrode active material for a lithium-ion battery, such as lithium combined metal oxide having a bedded salt structure, metal oxide having a spinel structure, or a polyanion compound. Alternatively, two or more kinds of positive electrode active materials may be used in combination. In the present embodiment, the positive electrode active material layer 22 contains olivine type lithium iron phosphate (LiFePO₄) as composite oxide.

The negative electrode active material layer 23 is not particularly limited, but has to be a material that is single, alloy, or a compound capable of charging and discharging charge carriers, such as lithium-ion. Examples of the negative electrode active material include Li, carbon, a metallic compound, and an element that may be alloyed with lithium or a compound of the element. Examples of the carbon include natural graphite, artificial graphite, hard carbon (non-graphitizing carbon), and soft carbon (graphitizing carbon). Examples of the artificial graphite include high orientation graphite and mesocarbon microbeads. Examples of the element alloyed with lithium include silicon and tin. In the present embodiment, the negative electrode active material layer 23 contains graphite as a carbon-based material.

Each of the positive electrode active material layer 22 and the negative electrode active material layer 23 (which may be simply referred to as the active material layer) may further include a conductive auxiliary agent for increasing electric conductivity as necessary, a binder agent, electrolyte (polymer matrix, ion-conducting polymer, electrolytic solution, or the like), electrolyte supporting salt (lithium salt) for increasing ion conductivity, and the like. The ingredients of the active material layer or the compound ratio of the ingredients, and the thickness of the active material layer are not particularly limited, and may refer to public knowledge about a lithium-ion battery. The thickness of the active material layer may range from 2 μm to 150 μm, for example. The active material layer may be formed on a surface of the electrode plate by a known method, such as roll coating. The surface(s) of the electrode plate or the surface of the active material layer may have a heat resistant layer to increase heat stability of the positive electrode 11 or the negative electrode 12. The heat resistant layer may include inorganic particles and a binder agent, and may further include an additive agent, such a thickener.

The conductive auxiliary agent may be added to increase the conductivity of the positive electrode 11 or the negative electrode 12. Accordingly, the conductive auxiliary agent may be arbitrarily added when the positive electrode 11 or the negative electrode 12 has insufficient conductivity, or may not be added when the positive electrode 11 or the negative electrode 12 has excellent conductivity. The conductive auxiliary agent may be acetylene black, carbon black, graphite, or the like.

The binder agent functions to hold the active material or the conductive auxiliary agent to the surface of the electrode plate. Examples of the binder agent include fluorine-containing resins, such as polyvinylidene difluoride, polytetrafluoroethylene, and fluorine rubber; thermoplastic resins, such as polypropylene and polyethylene; imide resins, such as polyimide and polyamide-imide; alkoxysilyl group-containing resins; acryl resins including monomeric units of acrylic acid, methacrylic acid, and the like; styrene-butadiene rubber (SBR); carboxymethyl cellulose; alginates, such as sodium alginate and ammonium alginate; water-soluble cellulose ester cross-link; and starch-acrylic acid graft polymers. These binder agents may be used independently or in combination. Examples of solvent include water and N-Methyl-2-pyrrolidone (NMP).

The separator 13 passes the charge carriers, such as lithium-ion, while separating the positive electrode 11 and the negative electrode 12 to prevent a short circuit due to a contact between the positive electrode 11 and the negative electrode 12. In each power storage cell 2, the separator 13 is arranged between the positive electrode 11 and the negative electrode 12. The separator 13 prevents a short circuit between the adjacent bipolar electrodes 10, 10 in the stacked power storage cells 2.

The separator 13 may be a porous sheet or non-woven material that includes polymers for absorbing and holding electrolyte, for example. For example, the material for the separator 13 is a porous film made of polypropylene (PP). Examples of the material for the separator 13 include woven material or non-woven material made of polypropylene, methylcellulose, or the like. The separator 13 may have a single-layer structure or a multi-layer structure. The multi-layer structure may include a ceramic layer or the like serving as the heat resistant layer. The separator 13 may be impregnated with the electrolyte. The separator 13 itself may be made of electrolyte, such as all-solid state electrolyte (polymer solid state electrolyte, inorganic solid state electrolyte).

Specifically, the electrolyte, with which the separator 13 is impregnated, may be a known material, such as liquid electrolyte (electrolytic solution), or polymer gel electrolyte. The electrolytic solution includes non-aqueous solvent and electrolyte dissolved in non-aqueous solvent. The polymer gel electrolyte includes electrolyte held in polymer matrix.

The electrolytic solution includes non-aqueous solvent and electrolyte dissolved in non-aqueous solvent. The non-aqueous solvent may be a known solvent, such as cyclic carbonates, cyclic esters, chain carbonates, chain esters, and ethers. These materials may be used independently, or two or more of the materials may be used in combination. The electrolyte may be a known lithium salt, such as LiClO₄, LiAsF₆, LiPF₆, LiBF₄, LiCF₃SO₃, LiN(FSO₂)₂, or LiN(CF₃SO₂)₂.

The spacer 14 is at least disposed between the first electrode plate 20 and the second electrode plate 21, and joined to or fixed to at least one of the first electrode plate 20 and the second electrode plate 21 (both of the first electrode plate 20 and the second electrode plate 21, or either the first electrode plate 20 or the second electrode plate 20). The spacer 14 includes an insulation material to obtain isolation between the first electrode plate 20 and the second electrode plate 21 so as to prevent a short circuit. In the present embodiment, the spacer 14 contains polyethylene (PE) that is resin and serves as the insulation material. Examples of the resin material for the spacer 14 include polystyrene, acrylonitrile-butadiene-styrene copolymer, modified polypropylene (modified PP), and acrylonitrile-styrene (AS) copolymer, in addition to polyethylene (PE).

In the present embodiment, the spacer 14 extends along an edge 20e of the first electrode plate 20 or an edge 21e of the second electrode plate 21. The spacer 14 is a frame that surrounds the positive electrode active material layer 22 or the negative electrode active material layer 23 as viewed from the stack direction.

In the present embodiment, the spacer 14 serves as a sealing portion having a frame shape for sealing a space S between the first electrode plate 20 and the second electrode plate 21. In the present embodiment, the spacer 14 arranged for each power storage cell 2 has a portion arranged between the pair of the electrode plates and a portion extending outward of the edges of the electrode plates. The space S surrounded by the spacer 14, the first electrode plate 20, and the second electrode plate 21 stores the electrolyte (electrolytic solution) with which the separator 13 is impregnated. In the present embodiment, the spacer 14 has a rectangular frame shape in planar view, and is welded to the edge 20e of the first electrode plate 20 and the edge 21e of the second electrode plate 21.

The spacer 14 seals the space S between the positive electrode 11 and the negative electrode 12, thereby preventing leak of the electrolyte. The spacer 14 seals the space S between the positive electrode 11 and the negative electrode 12, thereby preventing moisture intrusion from outside of the power storage device 1 into the space S. Furthermore, the spacer 14 may prevent gas, which is generated from the positive electrode 11 or the negative electrode 12, for example, due to charge or discharge reaction, from leaking outside of the power storage device 1. An edge 13e of the separator 13 is embedded in the spacer 14. In the present embodiment, the spacers 14 adjacent to each other in the stack direction are separated from each other. Accordingly, the surfaces of the side edges of the first electrode plate 20 and the second electrode plate 21 are exposed between the adjacent spacers 14, as viewed from the second direction (e.g., X-axis direction or Y-axis direction) intersecting the stack direction.

The power storage device 1 further includes a pair of positive and negative current collectors respectively disposed at one end and the other end of the stack 5 in the stack direction. Specifically, the positive electrode current collector 30, which has a rectangular shape as viewed from the stack direction, is disposed at the one end of the stack 5. The negative electrode current collector 40, which has a rectangular shape as viewed from the stack direction, is disposed at the other end of the stack 5. A surface 30a of the positive electrode current collector 30 is in contact with the other surface 20b of the first electrode plate 20 that is arranged as a terminal electrode. A surface 40a of the negative electrode current collector 40 is in contact with the other surface 21b of the second electrode plate 21 that is arranged as a terminal electrode.

Each of the positive electrode current collector 30 and the negative electrode current collector 40 (which may be simply referred to as the current collector) is formed of good electrically conductive material. The material for the current collectors is the same as the material for the electrode plates. The current collectors may be thicker than the electrode plates of the stack 5. In the present embodiment, the current collectors are larger than the stack 5 (power storage cells 2) as viewed from the stack direction, and extend outward of outer side surfaces 14b of the spacers 14. Each spacer 14 has, on opposite sides thereof, the outer side surface 14b and an inner side surface 14a that faces the space S in the spacer 14. The current collectors may be smaller than (or about the same as) the stack 5 (power storage cells 2) as viewed from the stack direction. In this configuration, the outer edges of the current collectors may be located inward of the outer side surface 14b of the spacer 14, as viewed from the stack direction.

The current collectors may have a terminal so that the current collectors may be used for charge and discharge of the power storage device 1 via the terminal, for example. Alternatively, the current collectors may be used to electrically connect a plurality of the power storage devices 1 stacked on top of each other via the current collectors. The current collectors may have a cooling function to cool the stack 5 (power storage cells 2). In this configuration, the current collectors may have a flow passage extending in an in-plane direction, for example, so that a cooling medium flowing through the flow passage exchanges heat with the stack 5.

Furthermore, a conductive layer (not illustrated) may be disposed between the first electrode plate 20 and the positive electrode current collector 30 at the one end of the stack 5 or between the second electrode plate 21 and the negative electrode current collector 40 at the other end of the stack 5 to obtain better conductive contact between the electrode plate and the current collector. In this configuration, the conductive layer may be in close contact with the other surface 20b or the other surface 21b of the electrode plates. The conductive layer may have hardness lower than that of the electrode plates, for example. The conductive layer may be a layer containing carbon, such as acetylene black or graphite, or coating layer containing Au.

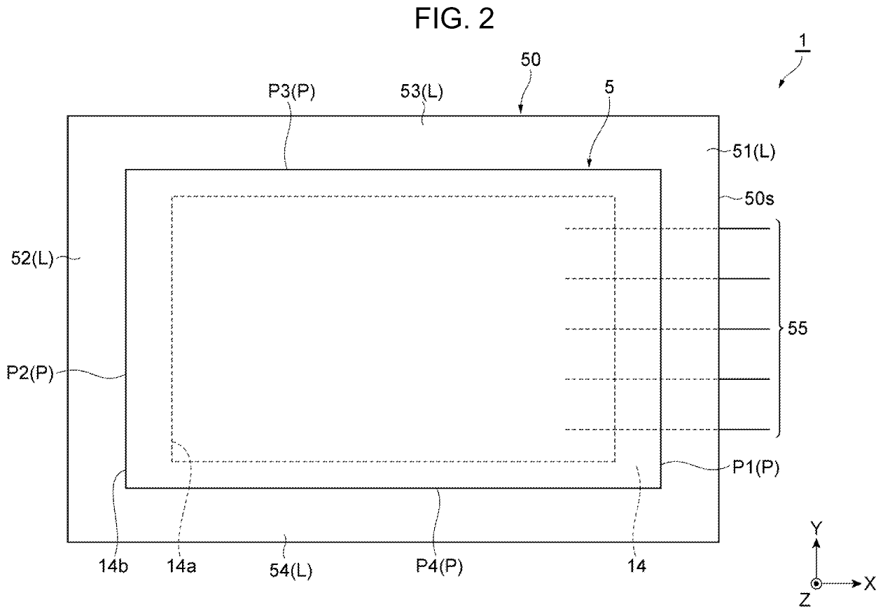

FIG. 2 is a schematic plan view of the power storage device illustrated in FIG. 1. FIG. 2 does not illustrate the current collectors respectively disposed at the one end and the other end of the stack 5. As illustrated in FIGS. 1 and 2, the stack 5 has outer side surfaces (stack side surfaces) P that extend in the stack direction. In the present embodiment, the stack 5 has a quadrangular shape as viewed from the stack direction, so that the stack 5 has four outer side surfaces (stack side surfaces) P1, P2, P3, P4 that respectively correspond to four sides of the quadrangular shape. Each of the outer side surfaces P is formed of the outer side surfaces 14b of the spacers 14 arranged in the stack direction and the surfaces of the side edges of the electrode plates exposed between the adjacent spacers 14. The power storage device 1 further includes a sealing member 50 on the outer side surfaces P.

The sealing member 50 is an insulating member for sealing the stack 5. The sealing member 50 is integrally disposed on whole of the outer side surfaces P1-P4. The sealing member 50 is disposed on (and is in contact with) the outer side surfaces P, i.e., the outer side surfaces 14b of the spacers 14 and the surfaces of the side edges of the electrode plates exposed between the adjacent spacers 14. In other words, the sealing member 50 enters between the adjacent spacers 14 to seal the surfaces (interfaces) of the side edges of the first electrode plate 20 and the second electrode plate 21 between the adjacent power storage cells 2. The sealing member 50 extends from the positive electrode current collector 30 to the negative electrode current collector 40 in the stack direction. In the present embodiment, the outer side surface 14b of each spacer 14 is located outward of the surfaces of the side edges of the electrode plates. In this configuration, the sealing member 50 may be in contact with the outer side surface 14b of the spacer 14 only.

The sealing member 50 is in contact with the surface 30a of the positive electrode current collector 30 at the one end of the stack 5, and is in contact with the surface 40a of the negative electrode current collector 40 at the other end of the stack 5. Accordingly, the sealing member 50 surrounds and seals whole of the stack 5 including the respective power storage cells 2. The sealing member 50 is formed of portions 51, 52, 53, 54 respectively disposed on the outer side surfaces P1, P2, P3, P4.

The material for the sealing member 50 may be silicon rubber, polyolefin, urethane rubber, or the like, for example. Specifically, the material for the sealing member 50 may be selected so that the elastic modulus of at least one of the portions 51-54 is lower than an elastic modulus of the spacer 14. In other words, at least, a portion of the sealing member 50 disposed on at least one of the outer side surfaces P1-P4 serves as a low elastic modulus portion L, which has an elastic modulus lower than that of the spacer 14. In the present embodiment, all of the portions 51-54 of the sealing member 50 have the same elastic modulus, and serve as the low elastic modulus portion L, for example. The elastic modulus of the low elastic modulus portion L of the sealing member 50 ranges from approximately 10 MPa to 600 MPa, and the elastic modulus of the spacer 14 ranges from approximately 100 MPa to 2000 MPa.

For example, such a sealing member 50 may be formed by applying the aforementioned material for the sealing member 50 to the outer side surfaces P of the stack 5, which is formed of the stacked power storage cells 2 with the current collectors respectively disposed on opposite sides of the stack 5, and hardening the material for the sealing member 50. If the sealing member 50 is formed by applying a melted material to the spacer 14, the material for the sealing member 50 may have a melting point lower than that of the material for the spacer 14 to reduce thermal influence on the spacer 14 in forming the sealing member 50.

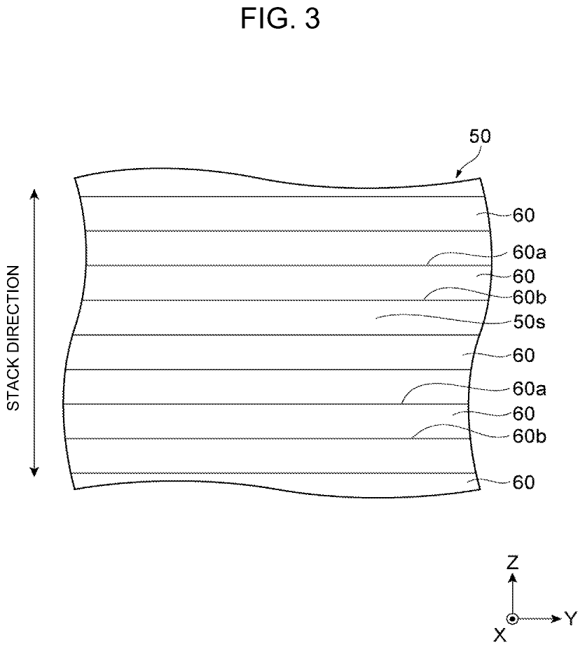

FIG. 3 is a partial side view of the power storage device illustrated in FIG. 1. As illustrated in FIGS. 1 and 3, an outer side surface 50s of the sealing member 50 has a plurality of grooves 60. The sealing member 50 has, on opposite sides of the sealing member 50, the outer side surface 50s and a surface that faces (and is in contact with) the outer side surface 14b of the spacer 14. The plurality of grooves 60 is arranged in parallel to each other as viewed from the direction (second direction) intersecting the stack direction, and extends in a direction perpendicular to the stack direction. The grooves 60 are formed in all of the portions 51-54 of the sealing member 50, for example. In the present embodiment, each groove 60 has a thickness-increasing portion in which the thickness of the sealing member 50 (a dimension of the sealing member 50 in a direction intersecting the outer side surface P) gradually increases in the stack direction, a thickest portion 60a in which the sealing member 50 is thickest, a thickness-decreasing portion in which the thickness of the sealing member 50 gradually decreases in the stack direction, and a thinnest portion 60b in which the sealing member 50 is thinnest, and these portions are alternatingly arranged to form the grooves 60.

Accordingly, the sealing member 50 does not have a flat portion in which the thickness is constant along the stack direction, but may have the flat portion. For example, the thickness of the sealing member 50 does not gradually increase and decrease as a whole along the stack direction, and may vary step by step (by stages). Alternatively, the sealing member 50 may be provided without the grooves 60, and may have a constant thickness. A relatively thick portion of the sealing member 50 is in contact with the surface 30a of the positive electrode current collector 30 and the surface 40a of the negative electrode current collector 40. Specifically, each groove 60 may be formed so that the sealing member 50 is in contact with the surface 30a or the surface 40a at the thickest portion 60a. In the present embodiment, the relatively thick portion of the sealing member 50 is arranged on the surfaces of the side edges of the electrode plates exposed between the adjacent spacers 14. Specifically, each groove 60 may be formed such that the thickest portion 60a corresponds to the interfaces of the first electrode plate 20 and the second electrode plate 21 between the adjacent power storage cells 2. In other words, in the present embodiment, the number of the grooves 60 correspond to the number of the stacked power storage cells 2. The number of the grooves 60 may be selected arbitrarily. When the number of the grooves 60 is different from the number of the stacked power storage cells 2, each groove 60 is preferably formed such that the thinnest portion 60b does not correspond to the interfaces of the first electrode plate 20 and the second electrode plate 21 between the adjacent power storage cells 2.

In the present embodiment, the thickness of the thickest portion 60a of the sealing member 50 is smaller than the thickness of the spacer 14 between the inner side surface 14a and the outer side surface 14b. The thickness of the thinnest portion of the sealing member 50 may be approximately 1 mm, for example.

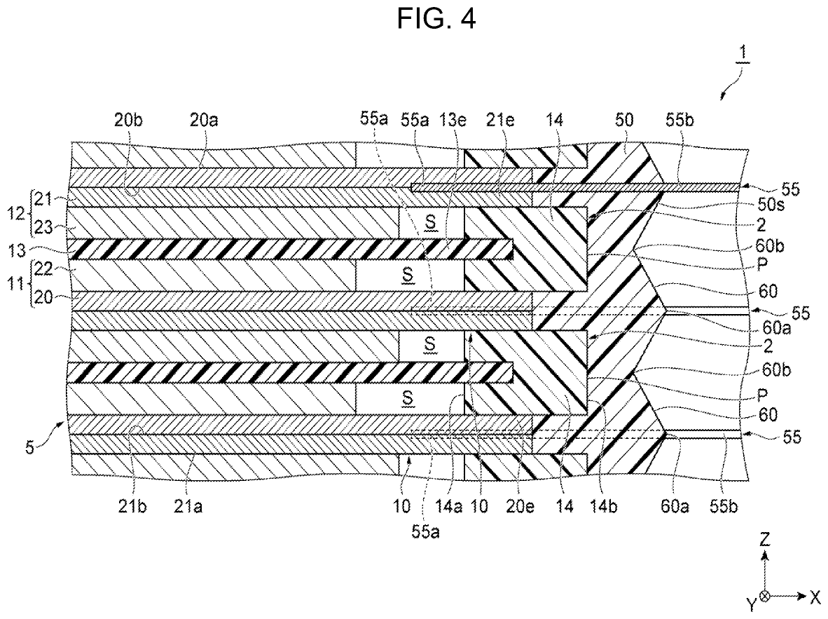

FIG. 4 is a partially enlarged sectional view of the power storage device illustrated in FIG. 1. As illustrated in FIGS. 2 and 4, the power storage device 1 includes a plurality of voltage detecting lines 55 respectively disposed in the power storage cells 2. In the present embodiment, each of the voltage detecting lines 55 is used for detecting the voltage of the corresponding power storage cell 2 as a state of the power storage cell 2. The voltage detecting line 55 extends into the inside of the stack 5 from outside of the sealing member 50 while passing between the spacers 14 of the adjacent two power storage cells 2.

Specifically, the voltage detecting line 55 has one end 55a and the other end 55b on opposite sides of the voltage detecting line 55. The one end 55a and the other end 55b of the voltage detecting line 55 are disposed inside of the stack 5 and outside of the sealing member 50, respectively. The outside of the sealing member 50 means outside of the outer peripheral surface of the sealing member 50 (opposite side of the stack 5) as viewed from the stack direction. Accordingly, the voltage detecting line 55 has, between the one end 55a and the other end 55b, a portion overlapped with the spacer 14 and the sealing member 50 as viewed from the stack direction. Each voltage detecting line 55 protrudes from the outer side surface 50s of the sealing member 50.

The one end 55a of the voltage detecting line 55 is disposed between the other surface 20b (of the first electrode plate 20) of one of the adjacent power storage cells 2 and the other surface 21b (of the second electrode plate 21) of the other of the adjacent power storage cells 2, and the one end 55a is in contact with the other surface 20b and the other surface 21b. Accordingly, the voltage detecting line 55 is electrically connected to the first electrode plate 20 of one of the adjacent power storage cells 2 and the second electrode plate 21 of the other of the adjacent power storage cells 2. The one end 55a is located only in areas of the first electrode plate 20 and the second electrode plate 21 on which the active material layers are not formed so as not to be located in areas where the positive electrode active material layer 22 faces the negative electrode active material layer 23 as viewed from the stack direction.

In the present embodiment, the respective voltage detecting lines 55 extend from one portion of the sealing member 50. In the present embodiment, all of the voltage detecting lines 55 extend from the portion 51 of the sealing member 50 disposed on the outer side surface P1, for example. In the present embodiment, all of the portions 51-54 of the sealing member 50 serve as the low elastic modulus portion L as described above. Accordingly, the portion 51 of the sealing member 50 disposed on the outer side surface P1 from which the voltage detecting lines 55 extend serves as the low elastic modulus portion L. The extending portions of the voltage detecting lines 55 of the sealing member 50 are spaced from each other along the direction intersecting the stack direction (in other words, an overlap between the adjacent extending portions as viewed from the stacking direction is prevented) so as to prevent a contact between the adjacent voltage detecting lines 55. Each voltage detecting line 55 extends from a relatively thick portion of the sealing member 50 (i.e., the thickest portion 60a).

The stack 5 of the power storage device 1 includes the plurality of power storage cells 2 stacked in the stack direction as described above. Each power storage cell 2 includes the positive electrode 11 and the negative electrode 12 stacked on top of each other, and the spacer 14 disposed between the positive electrode 11 and the negative electrode 12. Further, the outer side surfaces P of the stack 5 extending in the stack direction have thereon the sealing member 50 for sealing the stack 5. The sealing member 50 on all of the outer side surfaces P serves as the low elastic modulus portion L, which has an elastic modulus lower than that of the spacer 14 of the power storage cell 2. According to this configuration, if the power storage cell 2 is deformed due to any reason, such as expansion or displacement, the sealing member 50, which is relatively deformable, may sufficiently deform following the deformation of the power storage cell 2 while securing sealing performance. Therefore, the power storage device 1 may increase sealing performance.

In the power storage device 1, the first electrode plate 20 has the surface 20a and the other surface 20b on opposite sides of the first electrode plate 20, and the second electrode plate 21 has the surface 21a and the other surface 21b on opposite sides of the second electrode plate 21. The power storage device 1 includes the stack 5 including the stacked power storage cells 2, wherein the power storage cells 2 are stacked on top of each other such that the other surface 20b of the first electrode plate 20 of one of the power storage cells 2 is overlapped with the other surface 21b of the second electrode plate 21 of another one of the power storage cells 2 adjacent to the one of the power storage cells 2. This configuration generates an overlapping area of the electrode plates between the adjacent power storage cells 2. Accordingly, securing sealing performance of the relatively deformable sealing member 50 is effective against a displacement between the stacked power storage cells 2.

The power storage device 1 further includes the voltage detecting lines 55 that are each disposed between the other surface 20b and the other surface 21b adjacent to each other and connected to at least one of the first electrode plate 20 and the second electrode plate 21 so as to detect the state of the power storage cell 2, the voltage detecting lines 55 extend out from the sealing member 50, and a portion of the sealing member 50 disposed on at least one of the outer side surfaces P from which the voltage detecting lines 55 extend serves as the low elastic modulus portion L. This configuration allows the proximal portions of the voltage detecting lines 55 extending from the outer side surface P to be supported by a relatively soft portion of the sealing member 50. This configuration therefore allows the sealing member 50 to absorb vibration of the voltage detecting lines 55, thereby reducing breaking of the voltage detecting lines 55.

The power storage device 1 further includes the positive electrode current collector 30 and the negative electrode current collector 40 respectively disposed at the one end and the other end of the stack 5 in the stack direction, and the sealing member 50 has the grooves 60 extending in the direction intersecting the stack direction as viewed from the direction intersecting the outer side surface P. This configuration allows the grooves 60 to extend the creepage distance of the outer side surface P between the positive electrode current collector 30 and the negative electrode current collector 40. This configuration is likely to prevent water, which may be generated from moisture condensation on the surface of the sealing member 50, from flowing down on the outer side surface P, compared with a configuration where the sealing member 50 has a flat surface as a whole, for example. This prevents a short circuit between the positive electrode current collector 30 and the negative electrode current collector 40.

If the current collectors may be smaller than the stack 5 (power storage cells 2) and the outer edges of the current collectors may be located inward of the outer side surface 14b of the spacer 14, as viewed from the stack direction as described above, a short circuit between the current collectors is less likely to occur compared with a configuration where the outer edges of the current collectors are located outward of the outer side surface 14b of the spacer 14. In this configuration, the presence of the grooves 60 formed in the outer side surface 50s of the sealing member 50 extends the creepage distance of the outer side surface P between the positive electrode current collector 30 and the negative electrode current collector 40, thereby more reliably preventing a short circuit between the positive electrode current collector 30 and the negative electrode current collector 40.

In this power storage device 1, the spacer 14 has, on opposite sides thereof, the inner side surface 14a, which faces the space S between the first electrode plate 20 and the second electrode plate 21, and the outer side surface 14b, and the thickness of the sealing member 50 in the direction intersecting the outer side surface P is smaller than the thickness of the spacer 14 between the inner side surface 14a and the outer side surface 14b of the spacer 14. This configuration secures sealing performance while reducing the size of the power storage device 1.

In the power storage device 1, the melting point of the sealing member 50 is lower than the melting point of the spacer 14. This may reduce thermal influence on the spacer 14 when the sealing member 50 is formed by welding, slushing, or the like, thereby reducing a decrease in sealing performance.

The above embodiment is one aspect of the present invention. The present invention is not limited thereto and may be modified.

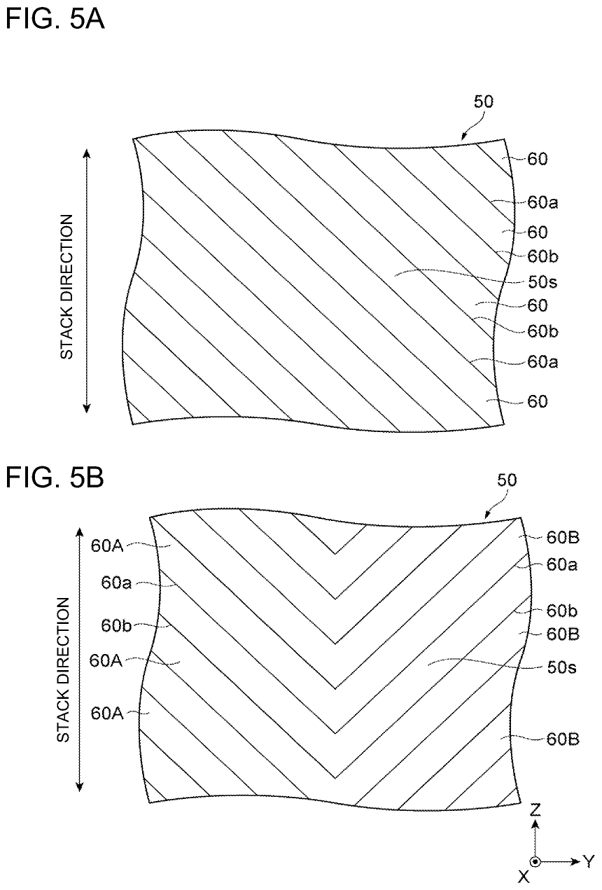

According to the embodiment, the grooves 60 extend in the direction perpendicular to the stack direction as viewed from the direction (second direction) intersecting the stack direction, but the grooves 60 may extend in various directions. FIG. 5 is a side view of grooves according to modifications. As illustrated in FIGS. 5(a), (b), for example, the grooves 60 may be arranged in parallel to each other and extend diagonally to the stack direction, as viewed from the direction (second direction) intersecting the stack direction. The inclination angle of the illustrated grooves 60 is approximately 45 degrees, but may be any angle that may guide the moisture along the grooves 60. In the modifications, all of the grooves 60 of at least one of the portions (portions 51-54) of the sealing member 50 extend in the same direction.

For example, at least one of the portions (portions 51-54) of the sealing member 50 may have a group of grooves 60A and a group of grooves 60B which have different inclination angles from each other, as illustrated in FIG. 5(b). In this modification, at least one of the portions of the sealing member 50 has the first group of grooves 60A arranged along the stack direction and inclined in one direction with respect to the stack direction, and the second group of grooves 60B arranged along the stack direction and inclined in another direction with respect to the stack direction, as viewed from the direction (second direction) intersecting the stack direction. In the illustrated modification, the inclination angle of the grooves B is set such that the grooves 60A and the grooves 60B intersect at right angles to one another. This configuration may guide the moisture toward the interfaces of the groups. The presence of the grooves 60, 60A, 60B may guide water, which may be generated from moisture condensation on the outer side surface 50s of the sealing member 50, in a desired direction.

In the modification illustrated in FIGS. 5(a) and 5(b), the grooves 60 are arranged in parallel to each other as like as the embodiment. The inclination angle of the grooves 60 with respect to the stack direction may be modified as necessary as long as the advantageous effects of the present invention are achieved. In the power storage device 1 according to the modifications, the presence of the grooves 60 may guide water, which may be generated from moisture condensation on the surface of the sealing member 50, in a desired direction. For example, this allows the water to be guided to a well-drained outlet, thereby preventing the water from flowing down on the outer side surface 50s of the sealing member 50. This configuration therefore more reliably prevents a short circuit between the positive electrode current collector 30 and the negative electrode current collector 40.

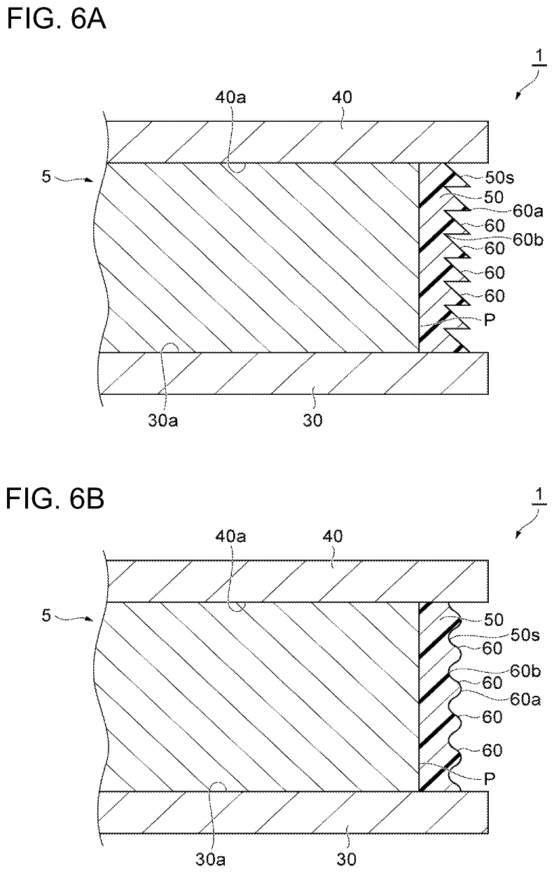

In the embodiment, each groove 60 has the thickness-increasing portion in which the thickness of the sealing member 50 gradually increases in the stack direction and the thickness-decreasing portion in which the thickness of the sealing member 50 gradually decreases in the stack direction, and these portions are alternatingly arranged. However, the configuration of the groove 60 is not limited thereto. For example, as illustrated in FIG. 6(a), the grooves 60 may have the thickness-increasing portion in which the thickness of the sealing member 50 gradually increases in the stack direction and a thickness-decreasing portion in which the thickness of the sealing member 50 discontinuously decreases in the stack direction, and these portions are alternatingly arranged. Alternatively, as illustrated in FIG. 6(b), the grooves 60 may have the thickness-increasing portion in which the thickness of the sealing member 50 gradually increases in the stack direction and the thickness-decreasing portion in which the thickness of the sealing member 50 gradually decreases in the stack direction, these portions may be alternatingly arranged, and a smooth portion connecting these portions may be formed (by chamfering).

In the embodiment, all of the portions 51-54 of the sealing member 50 have the same elastic modulus, and serve as the low elastic modulus portion L that has an elastic modulus lower than that of the spacer 14. However, as long as at least one of the portions 51-54 of the sealing member 50 serves as the low elastic modulus portion L, the other portion of the sealing member 50 may have the same elastic modulus as the elastic modulus of the spacer 14. For example, of the portions 51-54 of the sealing member 50, at least the portion 51 disposed on the outer side surface P1 from which the voltage detecting lines 55 extend has to serve as the low elastic modulus portion L to protect the voltage detecting lines 55. Furthermore, distribution of elastic moduli may be formed among all of the portions 51-54 of the sealing member 50. Also in this configuration, the portion 51 of the sealing member 50 disposed on the outer side surface P1 from which the voltage detecting lines 55 extend has to have an elastic modulus that is lower than those of the portions 52-54 of the sealing member 50 respectively disposed on the outer side surfaces P2-P4. In this configuration, the portions 52-54 of the sealing member 50 respectively disposed on the outer side surfaces P2-P4 except for the outer side surface P1 from which the voltage detecting lines 55 extend each have elastic modulus relatively higher than that of the portion 51 of the sealing member 50. This configuration may therefore reduce breaking of the voltage detecting lines 55 while securing the stiffness of the whole power storage module. In this configuration, all of the portions 51-54 of the sealing member 50 may serve as the low elastic modulus portion L, or one of the portions 51-54 of the sealing member 50 may not serve as the low elastic modulus portion L.

### REFERENCE SIGNS LIST

1 power storage device (power storage module)
2 power storage cell
5 stack
11 positive electrode (first electrode)
12 negative electrode (second electrode)
14 spacer
14a inner side surface
14b outer side surface
20 first electrode plate
20a surface (first surface)
20b the other surface (third surface)
21 second electrode plate
21a surface (second surface)
21b the other surface (fourth surface)
22 positive electrode active material layer (first active material layer)
23 negative electrode active material layer (second active material layer)
30 positive electrode current collector (current collector)
40 negative electrode current collector (current collector)
50 sealing member
55 voltage detecting line (detecting line)
60 groove
L low elastic modulus portion
P outer side surface (stack side surface)
S space

1. A power storage module comprising:
a stack including a plurality of power storage cells stacked in a first direction; and
a sealing member for sealing the stack, wherein
the stack has a plurality of stack side surfaces that extends in the first direction,
the sealing member is formed in contact with the stack side surfaces,
the power storage cells each include:
a first electrode including a first electrode plate having a first surface intersecting the first direction and a first active material layer formed on the first surface;
a second electrode including a second electrode plate having a second surface intersecting the first direction and a second active material layer having an electrode polarity different from an electrode polarity of the first active material layer and formed on the second surface, the second electrode being stacked on the first electrode such that the second active material layer faces the first active material layer; and
a spacer disposed between the first electrode plate and the second electrode plate and surrounding the first active material layer and the second active material layer as viewed from the first direction, and
a portion of the sealing member disposed on at least one of the stack side surfaces serves as a low elastic modulus portion that has an elastic modulus lower than an elastic modulus of the spacer.

2. The power storage module according to claim 1, wherein
the first electrode plate has the first surface and a third surface on opposite sides of the first electrode plate,
the second electrode plate has the second surface and a fourth surface on opposite sides of the second electrode plate, and
the stack includes the power storage cells that are stacked on top of each other such that the third surface of the first electrode plate of one power storage cell is overlapped with the fourth surface of the second electrode plate of another power storage cell.

3. The power storage module according to claim 2, wherein
the power storage module further includes a detecting line that is disposed between the third surface and the fourth surface adjacent to each other and connected to at least one of the first electrode plate and the second electrode plate to detect a state of the power storage cell,
the detecting line extends out from the sealing member, and
a portion of the sealing member disposed on at least one of the stack side surfaces from which the detecting line extends serves as the low elastic modulus portion.

4. The power storage module according to claim 3, wherein
the portion of the sealing member disposed on the one of the stack side surfaces from which the detecting line extends has an elastic modulus that is lower than an elastic modulus of the other portion of the sealing member disposed on the others of the stack side surfaces.

5. The power storage module according to claim 1, wherein
the power storage module further includes a pair of current collectors respectively disposed at one end and the other end of the stack in the first direction, and
the sealing member has a groove extending in a direction intersecting the first direction as viewed from a second direction intersecting the stack side surface.

6. The power storage module according to claim 5, wherein
the groove extends diagonally to the first direction as viewed from the second direction.

7. The power storage module according to claim 1, wherein
the spacer has, on opposite sides of the spacer, an inner side surface facing a space between the first electrode plate and the second electrode plate and an outer side surface, respectively, and
a thickness of the sealing member in a direction intersecting the stack side surface is smaller than a thickness of the spacer between the inner side surface and the outer side surface of the spacer.

8. The power storage module according to claim 1, wherein
a melting point of the sealing member is lower than a melting point of the spacer.
